(19) United States
(12) Patent Application Publication
(10) Pub. No.: US 2023/0359972 A1
(43) Pub. Date: Nov. 9, 2023

(54) SKILLS CERTIFICATION

(71) Applicant: Steady Platform LLC, Atlanta, GA (US)

(72) Inventors: Jason Robinson, Atlanta, GA (US); Adam Roseman, Atlanta, GA (US); Amanda Miguel, Atlanta, GA (US)

(21) Appl. No.: 18/142,814

(22) Filed: May 3, 2023

Related U.S. Application Data
(60) Provisional application No. 63/337,664, filed on May 3, 2022.

(51) Int. Cl. G06Q 10/0635; G06Q 10/1053

(52) U.S. Cl. CPC G06Q 10/0635; G06Q 10/1053

(57) ABSTRACT

Provided are systems and methods for building a skills certificate. In some embodiments, the host platform may be a web server, a cloud platform, a database, or the like, which hosts an application such as a mobile application, a progressive web application, or the like.

The present application claims the benefit of U.S. Provisional Application No. 63/337,664, filed on May 3, 2022, in the United States Patent and Trademark Office, the entire disclosure of which is incorporated herein by reference for all purposes.

### BACKGROUND

When a person interviews for a job opening with an employer, the person may provide a cover letter with typed content about themselves and a resume with information about their work history, education, skills, licenses, certifications, and the like. Such documents are often generated by the person themselves based on their own knowledge. The content within the resume can be difficult and time-consuming for a potential employer to verify. In many cases, such as smaller companies that do not have a significant human resources department, the prospective employer will take the person's word for their work history and skills. The result oftentimes is that employers can hire people that are unqualified, or they may ignore people they mistakenly believe are unqualified, which are highly problematic situations that could likely have been avoided, had the employer only had the facts presented from a neutral authority.

### BRIEF DESCRIPTION OF THE DRAWINGS

Features and advantages of the example embodiments, and the manner in which the same are accomplished, will become more readily apparent with reference to the following detailed description taken in conjunction with the accompanying drawings.

FIG. 1A is a diagram illustrating a host platform that is configured to generate a skills certificate in accordance with an example embodiment.

FIG. 1B is a diagram illustrating an example of the skills certificate that is created by the host platform in FIG. 1A, in accordance with an example embodiment.

FIG. 1C is a diagram illustrating a verification process for verifying a skills certificate in accordance with an example embodiment.

FIGS. 2A-2C are diagrams illustrating examples of a blockchain network for skills certificate generation and verification in accordance with example embodiments.

FIG. 3A is a diagram illustrating a data ingestion process of a host platform in accordance with example embodiments.

FIGS. 3B-3D are diagrams illustrating a process of verifying a user based on personally-identifiable information (PII) in accordance with example embodiments.

FIGS. 4A-4C are diagrams illustrating a process of verifying income-based records in accordance with example embodiments.

FIGS. 5A-5C are diagrams illustrating a process of enhancing transaction records in accordance with example embodiments.

FIGS. 6A-6B are diagrams illustrating processes of reconciling transaction records in accordance with example embodiments.

FIG. 7A is a diagram illustrating a process of verifying eligibility and/or matching of a user's information in accordance with an example embodiment.

FIG. 7B is a diagram illustrating a process of automatically disbursing future benefit payments, updating a user's work application information, or the like, in accordance with an example embodiment.

FIG. 8 is a diagram illustrating a method of generating a certified skills document in accordance with example embodiments.

FIG. 9 is a diagram illustrating an example of a computing system for use in any of the examples described herein.

Throughout the drawings and the detailed description, unless otherwise described, the same drawing reference numerals will be understood to refer to the same elements, features, and structures. The relative size and depiction of these elements may be exaggerated or adjusted for clarity, illustration, and/or convenience.

### DETAILED DESCRIPTION

In the following description, details are set forth to provide a reader with a thorough understanding of various example embodiments. It should be appreciated that modifications to the embodiments will be readily apparent to those skilled in the art, and generic principles defined herein may be applied to other embodiments and applications without departing from the spirit and scope of the disclosure. Moreover, in the following description, numerous details are set forth as an explanation. However, one of ordinary skill in the art should understand that embodiments may be practiced without the use of these specific details. In other instances, well-known structures and processes are not shown or described so as not to obscure the description with unnecessary detail. Thus, the present disclosure is not intended to be limited to the embodiments shown, but is to be accorded the widest scope consistent with the principles and features disclosed herein.

The example embodiments are directed to a host platform such as a web server, a cloud platform, a blockchain network, or the like, which can build a skills certificate for a user based on information provided by the user and subsequently verified as trustworthy or authentic by the host platform. The skills certificate can be created in digital form with relevant skills, work experience, educational experience, licenses, certificates, etc. pre-populated within the document. The host platform may also add certifications to the document, such as signatures or other marks indicating which skills (e.g., work experience, education, licenses, skills obtained, etc.) have been verified by the system. The host platform may send the document to the user, for example, to a mobile application running on the user's mobile device. As another example, the host platform may attach the skills certificate to a message such as a SMS message or an email message and send the skills certificate via a message.

The platform described herein may perform the activities of the platforms described in U.S. patent application Ser. No. 17/968,855, filed on Oct. 19, 2022, in the United States Patent and Trademark Office, described in U.S. patent application Ser. No. 17/864,589, filed on Jul. 14, 2022, in the United States Patent and Trademark Office, described in U.S. patent application Ser. No. 17/342,622, filed on Jun. 9, 2021, in the United States Patent and Trademark Office, described in U.S. patent application Ser. No. 17/580,721, filed on Jan. 21, 2022, in the United States Patent and Trademark Office, described in U.S. patent application Ser. No. 18/113,137, filed on Feb. 23, 2023, in the United States Patent and Trademark Office, and described in U.S. patent application Ser. No. 17/888,630, filed on Aug. 16, 2022, in the United States Patent and Trademark Office, the entire disclosures of which are incorporated herein by reference for all purposes and may be used with the example embodiments.

As changes in the job market and the recent pandemic have caused a shift away from automatable jobs of the past and a shift towards more skills-based hiring, there is a need for a person interested in finding available employment to be able to quantify their experience beyond the traditional resume. The example embodiments are directed to a skills certification process which is used to verify a user's historical achievements including work history, education, payroll, skills obtained, and the like. The host platform may ingest data related to previous or current jobs of the person to provide a list of skills that a given user is believed to possess based on market data, combined with verified employment history. This certification process may be broken up into the following components:
(i) A service to collect work history (e.g., experience, skills, and the like) and identify a relevant skills list based on both third party and internal data.
(ii) A service to validate skills where applicable.
(iii) A service to verify employment history, which may include nontraditional or non-standard income.
(iv) A returned product in the form of a skills document that a worker can use with prospective employers.
(v) Authenticity can be guaranteed by recording in a trusted datastore and/or on an appropriate blockchain, as appropriate.

Some of the benefits of the system and process described herein including implementing a platform that can easily digest a skills list that can serve as an augmentation of or as an alternative to a resume or a cover letter for a user who is trying to search for a job. The system can help the user compile the list of skills using existing market data, making the process easier for a worker who may not have the time or knowledge to compile their own.

The system can verify employment history, which may include both employee/W-2 employment, as well as nontraditional or non-standard income, which may be recorded on a 1099 form or the like. In addition, the system can output a document (e.g., a digital document such as a pdf document, a word processing document, a spreadsheet, a CSV file, an XML file, a JSON file, or the like), which is tailored to what employers are looking for or may be interested in from employees. The document may include a list of skills identified by the host platform and an indicator, such as a tag, signature, mark, or other content within the document that indicates which skills have been verified by the host platform, and which skills are unverified (or possibly just common knowledge in the art, etc.).

Some of the drawbacks addressed by the example embodiments include an automated document generation process, which creates a document that a person can take with them into a job interview or other employment opportunity to give (i.e., hand over, email, upload, or otherwise provide) to prospective employers. The host platform may pre-populate the document with a list of skills of the person identified from the person's history and compile a list of skills in an organized fashion for the person. The host platform may also perform an employment verification which leverages core technology of verifying income and employment history, even for the nonstandard or non-traditional worker. The system also provides a method by which to validate a user's skills. The validation can be certified by the host platform. Here, the host platform may add or otherwise embed a signature such as a digital signature or other mark such as a hologram, quick response (QR) code, barcode, etc., inside the document (skills certificate), which lets the employer know which skills have been verified by the host platform, which in this case is an unbiased third-party.

The skills certification process may include one or more of the following steps, however the embodiments are not expressly limited hereto. Other steps may be performed, or steps listed below may not be performed. Also, the steps may be performed in a different order and some of the steps may be performed at the same time (i.e., simultaneously). For example, a user may provide their work experience history. The host platform may compile their work history and query internal data sources for what skills are commonly associated with those jobs (e.g., which are mapped to an O*NET job code corresponding to data in the user's work history, etc.) based on user submitted/third party/market level data. Where applicable, the host platform may perform a validation to verify that those skills are held by the user.

Validation of a skill can be sourced/verified in several ways, including a survey on relevant experience, user attestation, a skills test which asks questions and gauges user response, communications, and the like. The verified skills process may be performed automatically. For example, a script may execute and perform various message communications. Other validation procedures may include a “certification” provided by an external source such as an authorized entity of such certificate. The certificate or other document data may be uploaded to the system and stored in relation with the user's skills certificate.

Unvalidated skills may be indicated as being commonly found based on market data, e.g., data derived from job postings, job descriptions, government databases and standards, and the like, but not necessarily verified. The host platform may verify employment history related to each work type. The host platform may compile the final skills list and verification information, which can be provided in various formats and delivery mechanisms, for example directly to the user in a report format for job-search processes and/or to businesses, to government entities, to NGO entities, and the like. Relevant metadata related to the report can be written to an appropriate blockchain or trusted data store. The user, employers, and others can then query to substantiate authenticity of the output.

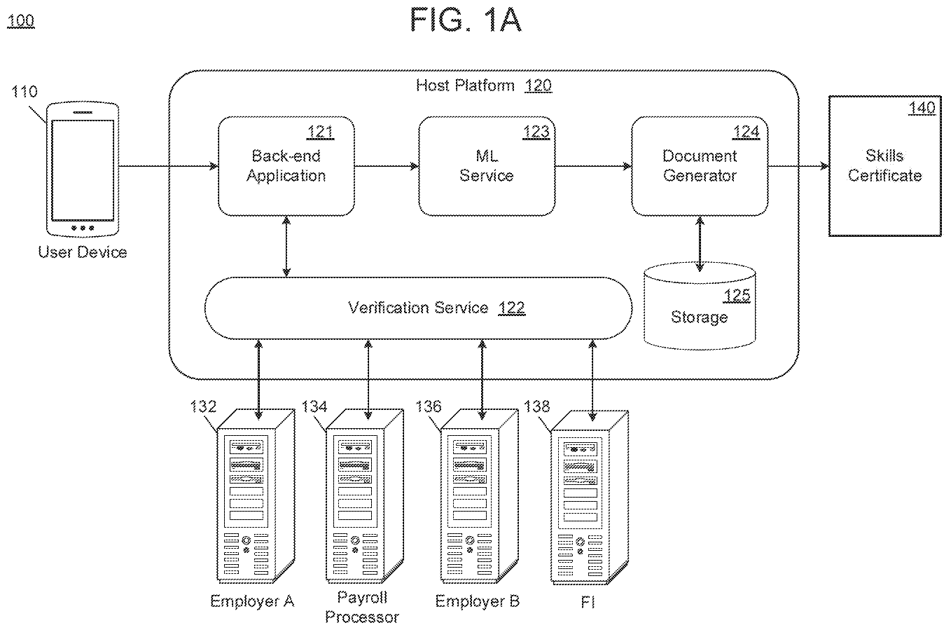

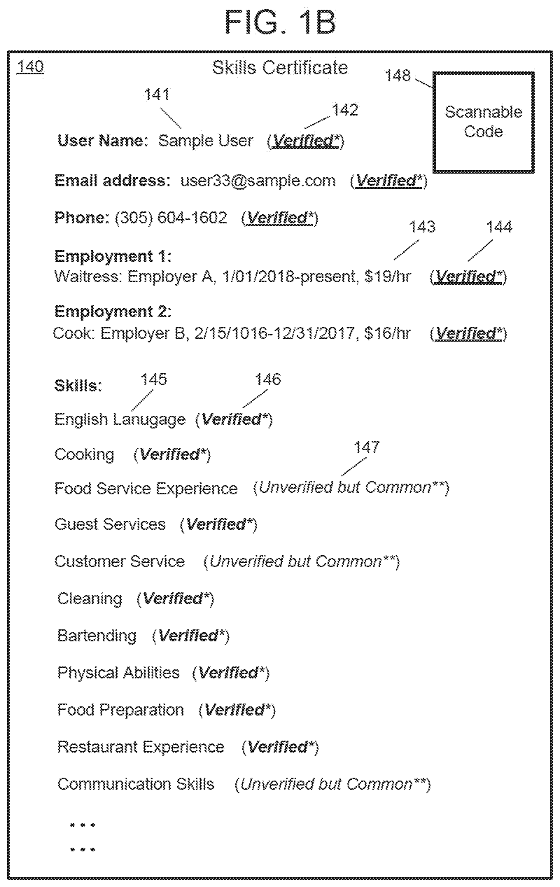

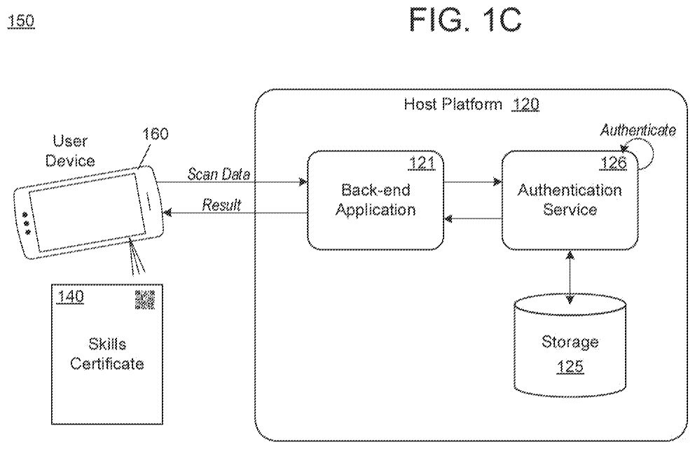

FIG. 1A illustrates a host platform 120 that is configured to generate a skills certificate 140 in accordance with an example embodiment. The host platform 120 may be accessible via the Internet and may host a software application or a suite of applications, including, but not limited to, a mobile application, a web application (e.g., a progressive web application, etc.), a service, a group of services, an application programming interface (API) or multiple APIs, and the like. The host platform 120 may be a cloud platform, a web server, a database or collection of databases, a distributed network of devices such as a blockchain network, a combination of systems and/or networks, and the like.

Referring to FIG. 1A, a user may access the host platform 120 via a user device 110 and may connect to a URI or other IP address that contains application content hosted by the host platform. Here, the user device 110 may open a front-end of the software application (not shown) on a screen of the user device 110 which interfaces with a back-end application 121 installed and deployed on the host platform 120. The user may upload documents, images, content, certificates, transcripts, paystubs, W-2s, W-4s, 1099s, and the like to the back-end of the application 121 on the host platform 120. The host platform 120 may ingest the data and create a data record for the user. Each user may be assigned a unique identifier by the host platform 120 and the same identifier may be added to the data record created for the respective user. The data record may include a document, a file, a database table, or the like. As another example, the data record may be contained or held within a topic such as would be found in a Kafka cluster. As just an example, the data may be ingested by an enrichment pipeline such as described in U.S. patent application Ser. No. 17/968,855, filed on Oct. 19, 2022, in the United States Patent and Trademark Office. In this example, the ingested data may include skills data that is enriched with additional attributes by the enrichment pipeline.

The ingested data may be organized into a list of skills. In some embodiments, the host platform 120 may use predefined codes associated with a particular job type to figure out which skills are associated with the jobs the user has performed. For example, if the user submits information indicating they have experience as a waiter/waitress, then the host platform 120 may query an internal data store or a third-party data store (e.g., via an API, etc.) for O*NET (or similar) job codes associated with the particular job type. In this example, the query may return a set of skills such as the following:

Waiter/Waitress

```
[
  “English”
  “Cooking”
  “Food Service Experience”
  “Food Delivery”
  “Guest Services”
  “Cleaning”
  “Customer Service”
  “Physical Abilities”
  “Food Preparation”
  “Bartending”
  “Organizational Skills”
  “Communication Skills”
  “Restaurant Experience”
  “Teamwork / Collaboration”
]
```

This list may be returned by querying the internal data store with an identifier of a job type (e.g., waiter/waitress, etc.). In other words, the query may contain an identifier of the job type and the query results may include skills that are mapped to that job type by the O*NET system, or the like. The O*NET system may be accessed directly or downloaded to an internal data store of the host platform on a periodic basis (e.g., monthly, quarterly, etc.), based on when the O*NET system is updated, which could be every quarter.

The host platform 120 may include a verification service 122 that is capable of verifying whether or not the user has obtained the skills included in the O*NET job codes by establishing secure channels with external data sources such as a payroll processing server that holds payroll information of the user, an employer server which holds employment information of the user, a licensing agency, a certification agency, or the like. The verification service 122 may establish an authenticated channel with any of these outside sources such as an employer 132, a payroll processor 134, and a second employer 136 as shown in FIG. 1A.

The verification service 122 may create individual/separate communications channels using different authentication mechanisms of the respective sources (e.g., the employer 132, the payroll processor 134, the second employer 136, financial data source that contains income from claimed employer, etc.), a financial institution (“FI”) 138, and the like. The FI 138 may verify.

For example, the verification service 122 may connect to and access different APIs of the different external data sources to establish the secure authenticated communication channels. In addition, the verification service 122 may query data files and records of the user via the established authentication channels to obtain information about the user that can be used to verify whether or not the user possesses the requisite skills associated with the job type. In the case that these sources contain Personally Identifiable Information (PII) for the individual, the data can also be used to verify not just the skills associated with the data, but that the person creating the certification is actually the same as the work data being collected using methods such as those described in U.S. patent application Ser. No. 17/580,721, filed on Jan. 21, 2022, in the US Patent and Trademark Office, the entire disclosure of which is incorporated herein by reference. This identity verification is even more effective when these sources are accessed via user-permissions that require authentication such as username/password and MFA.

The results of the verification process(es) may be stored in a storage 125 along with the messages themselves that are exchanged.

In some embodiments, the host platform 120 may also include or be connected to a machine learning service 123 that includes one or more machine learning models for identifying, evaluating, recommending, or otherwise processing information from the skills data and the validation/verification data. For example, the machine learning models may identify and/or recommend optimal job opportunities for a user based on other opportunities that are performed by other users in the community using the data that has been ingested. The optimal or otherwise beneficial job opportunity information may be output to the user via a mobile application, website, or the like. Information about the optimal job opportunities, including job titles, scheduling, average pay earned by others working such job opportunities, and the like, can be output through a visualization that is provided to the user.

The host platform 120 also includes a document generator 124 which is a service that can create a digital document (skills certificate 140) and populate the digital document with attributes of the user including identifiers of which attributes (skills) of the user have been externally verified by the host platform 120 and which attributes have not been verified. The digital document may be embodied in the form of a PDF file, a CSV file, a JSON file, an XML file, or the like. For example, the document generator 124 may generate a word document and capture a picture and render it inside the digital document to generate the skills certificate 140. As another example, the document generator may print the word document causing it to convert from a word document into a digital document to generate the skills certificate 140. Any other digital document techniques may be used. The document itself may include human-readable descriptions of the user. The skills certificate 140 may be delivered to the user device 110 via a message or via the application itself. In addition, the host platform 120 may securely deliver the skills certificate 140 to any other systems and employers that the user desires.

FIG. 1B illustrates an example of the skills certificate 140 that is created by the host platform 120 in FIG. 1A, in accordance with an example embodiment. Referring to FIG. 1B, the host platform 120 may populate the document with information 141 about the user such as the user's name, address, email address, phone number, etc. In addition, the host platform 120 may populate the skills certificate 140 with relevant employment history 143, relevant educational history, skills 145 obtained by the user, and the like. In addition, the host platform 120 may also add verification indicators 142, 144, 146, etc. within the skills certificate 140, which indicates which skills and other attributes of the user have been successfully verified by the host platform 120 with a third-party and which skills and other attributes have not been verified. In addition, in some cases, the host platform may add an identifier 147, comments, or the like, which indicates that a skill is commonly held by people in that industry, without actually verifying that the user holds those skills.

According to various embodiments, the skills certificate 140 may be assigned a unique document identifier by the host platform 120. Furthermore, prior to being delivered to the user, a label 148 or other indicia, marking, code, identifier, reference, link, etc., may be added to the skills certificate 140 to indicate that the skills certificate 140 is authentic. In some embodiments, the label 148 may include a scannable code such as a QR code, barcode, hologram, etc. that can be scanned by an imaging element of a mobile device. When scanned, the code may trigger the mobile device to send the document identifier of the skills certificate 140 along with other data from the skills certificate 140 for verification purposes such as a list of content within the skills certificate 140, etc.

The skills certificate 140 (i.e., the digital document) may be stored within the storage 125 along with the unique document identifier. In some embodiments, the storage 125 may also store a mapping between the unique document identifier and a location of the document in the storage 125. Accordingly, a controller or other management system of the storage 125 may subsequently be queried to retrieve and verify the content within the skills certificate 140 that is stored in the storage 125.

For example, FIG. 1C illustrates a process 150 of authenticating the skills certificate 140 by querying the storage 125. Referring to FIG. 1C, a user may use a user device 160 to scan the label 148 on the skills certificate 140. In response, the user device 160 may send a message to the host platform (e.g., via the back-end of the application 121) to an authentication service 126. The message may include a document identifier and other skills certificate data read from the label 148. The authentication service 126 (shown in FIG. 1C) may receive the message from the user device 160, and query the data store 125 based on the document identifier received from the user device. In this example, the document identifier maps to the skills certificate 140. In some embodiments the user of device 160 need not be the user about whom the skills certificate 140 refers, but the user of device 160 could be a potential employer, another verification service, or the like.

In response, the authentication service 126 may display a copy of the skills certificate 140 that it has stored in the storage 125 on the user device 160. As another example, the authentication service 126 may confirm any skill-based content provided from the user device 160 without displaying the skills certificate 140. For example, the scan data sent from the user device 160 to the authentication service 126 may include a list of skills and their verification status. The authentication service may read the list of skills from the skills certificate 140 stored in the storage 125, and compare it to the list of skills and verification status included in the scan data to determine if it's a match. If so, the authentication service 126 can output a success notification on the user device 160. If not a match, the authentication service 126 may output an error notification.

The example embodiments may rely on a standardization of data referred to as the Occupational Information Network (“O*NET”) system, which is an online database that contains occupational definitions including predefined codes assigned to different job titles and predefined fields/attributes assigned to each job title. In addition to job titles, the O*NET system also provides a list of skills associated with each job type. At present, there are around 1,000 predefined job titles, and more than 40,000 alternate titles, in the O*NET database along with skills/attributes of each. The O*NET database is continually updated with occupation information (e.g., on a quarterly basis, etc.). The example embodiments may rely on O*NET job codes that are assigned to different occupations and use these job codes as a way to map data within the host platform. For example, an ingested job history or skills history of a user may be mapped to a predefined O*NET job codes. This mapping, which may include processing to filter, combine, order, weight, or otherwise augment the job history and/or skills history, may then be used to query additional web-based services for additional information (e.g., via API calls, etc.) such as for the purposes of validation of the ingested job history. The queried/returned data can be added to the skills certificate and it can be processed by machine learning models for other analysis.

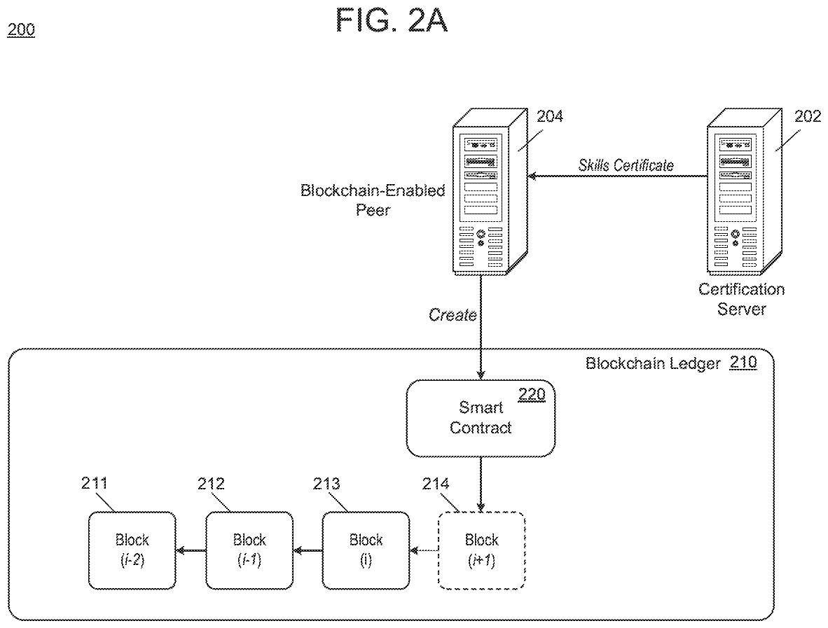

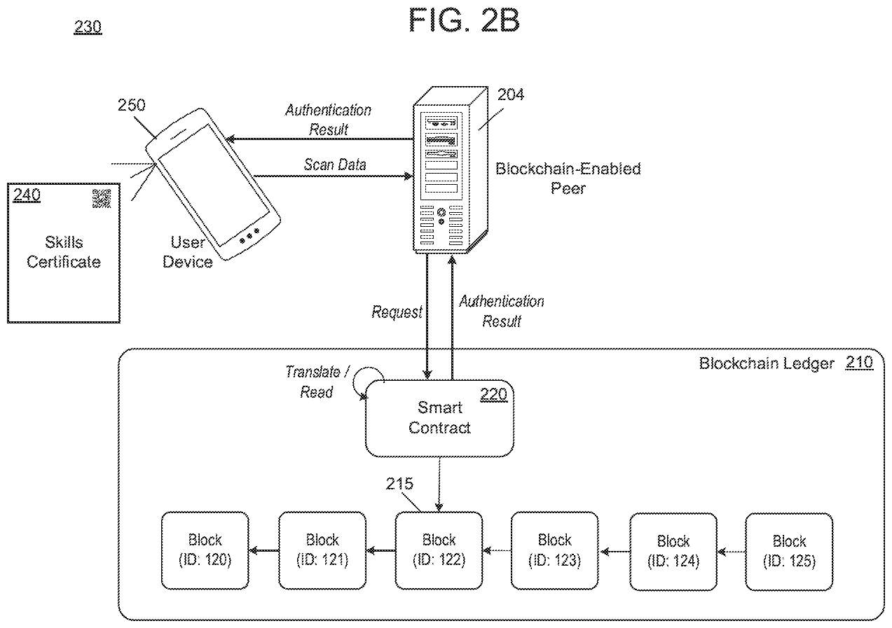

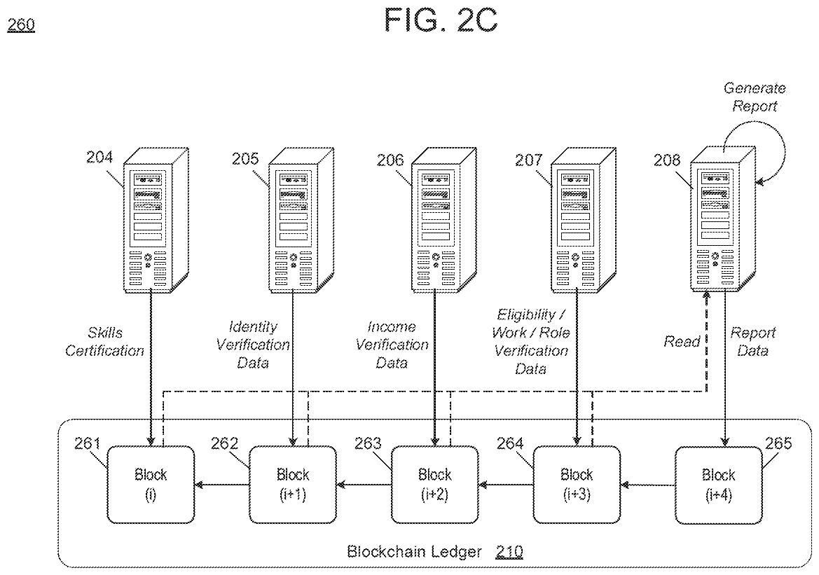

In some embodiments, the host platform 120 may be embodied within a blockchain peer or in a computing system that is otherwise coupled to a blockchain-enabled peer and has access to a blockchain ledger. In addition, in some embodiments, the skills certification process described herein may be performed in combination with one or more other verification process such as further described herein with respect to FIGS. 2A-9.

Referring to FIG. 2A, there is shown a process 200 of writing a skills certificate to a blockchain ledger 210. For example, a blockchain-enabled peer 204, which manages a blockchain ledger 210 along with other blockchain-enabled peers (not shown), may receive a message or other request from a certification server 202 or other system. The message may include a skills certificate (digital document), reference identifier, metadata, or the like to be committed to the blockchain ledger 210. The digital document may be hashed, encrypted, etc., and then stored the blockchain ledger 210 via a smart contract 220 installed on the blockchain ledger 210. The smart contract may include logic that reads from and writes to the blockchain ledger 210.

In the example of FIG. 2A, the skills certificate is written to a block 214 on the blockchain ledger 210, which is a next/new block in the chain of blocks 211, 212, and 213. As an example, the skills certificate may be committed to the blockchain ledger 210 via execution of a blockchain transaction. Other information about the user and the skills certificate such as the unique document identifier and the like may be included within the block 214, or another block, as appropriate for the particular embodiment, as well. Although not shown, each new block added may be approved via a blockchain consensus process such as a validate, order, and commit process, as is known in the art of blockchain.

FIG. 2B illustrates a process 230 of verifying a skills certificate 240 that has already been registered with the blockchain ledger 210 shown in FIG. 2A in accordance with an example embodiment. Referring to FIG. 2B, a user device 250 may scan a label or code on the skills certificate 240 which triggers the user device 250 to transmit an authentication request to the blockchain-enabled peer 204. The authentication request may include an identifier of the skills certificate 240 found in the scanned code (e.g., document identifier, etc.), content from the skills certificate found in the scanned code, a user identifier, and the like. In response, the blockchain-enabled peer 204 may query the blockchain ledger 210 to verify the skills certificate 240.

For example, the blockchain-enabled peer 204 may query the blockchain ledger 210 via the smart contract 220 which translates the document identifier received in the authentication request into a block location of block 215 on the blockchain ledger 210. The smart contract 220 may access, translate, read, decrypt, or otherwise process any skills certificate content stored on the blockchain ledger 210 and pass it back to the blockchain-enabled peer 204. As another example, the smart contract 220 may also receive skill content from the skills certificate 240 and compare it to the skills certificate content stored on the blockchain ledger 210 to verify whether or not it is authentic. The authenticity may be passed back to the blockchain-enabled peer 204. The results of the authenticity check may be output from the blockchain-enabled peer 204 to the user device 250 and may include skills certificate content, success/fail notifications, and the like.

FIG. 2C illustrates an example of a computing system (e.g., a blockchain network 260) which may carry out the skills certification process in parallel with and in combination with a number of other verification processes including identity verification; income verification; job posting, work, role, etc. eligibility verification; and the like. Furthermore, a report may be generated and provided based on the combination of processes. While the computing system is a blockchain network in this example, other embodiments could instead use a web server, cloud platform, database, or the like, without blockchain.

Referring to FIG. 2C, the blockchain network 260 includes a plurality of blockchain-enabled peers 204, 205, 206, 207, and 208 that may perform and/or facilitate the verification processes in sequence and in parallel. In some cases, multiple peers may perform the same verification process and confirm with each other via a consensus mechanism such as a blockchain endorsement process based on an endorsement policy (e.g., requirements, conditions, rules, etc.), which can be embodied within a blockchain smart contract configured to read and write data to the shared blockchain ledger. As another example, one or more of the peers may perform different verification processes at the same time enabling parallel verification of multiple types via multiple systems simultaneously. In the example of FIG. 2C, the blockchain-enabled peer 204 performs the skills certification process described herein and store a skills certificate for a user in a block 261 on the blockchain ledger 210.

This process may include functionality to determine eligibility for particular roles, enable the ability to process updates to skills certificates, or even be part of a larger process such as a benefit administration process. It's important to appreciate that this functionality could be related to gaining employment, certifying for benefits, maintaining benefits, or the like. As with the process of generating skills certificates, the benefit administration process may include registering a user via their device. For example, the user may download and install a copy of a mobile application or open a web browser and navigate to a web application via a URL. In response to prompts from an application, the user may be required to provide registration information such as details about the user including name, address, email, contact, etc. and also may be required to create a username and password. In addition, the user may provide login credentials or other access means, such as keys, tokens, smart-contract-based credentials, and the like, which enable the host platform to establish an authenticated channel with the user's financial institutions to inspect transaction records from the user's account or accounts, an employer, a payroll provider of the employer, and the like. Also, the user may provide permission to the host platform to access corresponding user records held by any of the user's financial institutions, employer, payroll provider, benefit administration programs, and the like. The blockchain-enabled peer 204 may record the user data obtained from the registration process, including the user's details, in a blockchain transaction stored within a block 261 which is committed to the blockchain ledger 210.

In some cases, the host platform may create a separate instance of a blockchain for each user. In this example, the block 261 would be a genesis block (first block of the blockchain—or block zero) for that specific user upon initial user registration and account creation. As another example, multiple users and their data may be intertwined within the same blockchain, which naturally has a single genesis block, instead of a genesis block per user.

Referring back to FIG. 2C, blockchain-enabled peer 205 executes an identity verification process based on the data uploaded, onboarded, or otherwise provisioned by the user, including data ingested from the user data records held by the user's financial institutions, employer, payroll provider, and the like. In other embodiments, the blockchain-enabled peer 205 could interface with a separate platform that performs identity verification, or be responsible for any and all parts of the administration and verification process. The results of the identity verification process may be recorded by the blockchain-enabled peer 205 in a block 262 which is committed to the blockchain ledger 210. Examples of the identity verification process are described in U.S. patent application Ser. No. 17/580,721, filed on Jan. 21, 2022, in the United States Patent and Trademark Office, the entire disclosure of which is incorporated herein by reference for all purposes.

Blockchain-enabled peer 206 executes an income verification process based on the data onboarded by the user including data ingested from the user transaction records held by the user's financial institutions, employer, payroll provider, and the like. Examples of the income verification process are described in U.S. patent application Ser. No. 17/580,721, filed on Jan. 21, 2022, in the United States Patent and Trademark Office, the entire disclosure of which is incorporated herein by reference for all purposes. In addition, examples of income verification are described herein below. The results of the income verification process may be recorded by the blockchain-enabled peer 206 in a block 263 which is committed to the blockchain ledger 210. For example, the result may include a pass/fails status, identifiers of any suspicious data records, identifiers of any other users, and the like.

Blockchain-enabled peer 207 executes an eligibility verification process based on the data onboarded by the user including data ingested from the user transaction records held by the user's financial institutions, employer, payroll provider, and the like. The eligibility verification process may be conditioned on approval by successful execution of a skill or lack of skill in the skill certification process, the identity verification process, and/or the income verification process, including any instances of fraudulent behavior that are detected during either verification process. The eligibility verification process may compare information about the user's assets, income, identity, geography, and the like, to requirements for eligibility set forth by the benefits program that the user wishes to obtain benefits from. A result of the eligibility determination may be recorded in a block 264 committed to the blockchain ledger 210. The result may include a pass/fail eligibility determination, an indication of any requirements that the user does not satisfy and why, and the like.

As an example, the blockchain-enabled peer 207 may identify a geographic location of the user based on various data records that are obtained during the registration process or pulled/ingested from connected user accounts (such as bank accounts, etc.) to determine a geographical location where the user is currently residing. This location can then be compared to any geographical requirements of the benefit program. As another example, the blockchain-enabled peer 207 may identify a pattern of income (e.g., monthly, weekly, etc.) for the user based on transaction records which are ingested from connected financial accounts of the user and compare the income to any income requirements of the benefits program.

Blockchain-enabled peer 208 may read the user's data from any of the block 261, the block 262, the block 263, and the block 264 and generate a report which includes human-readable information about the results of the different verifications and the eligibility check. The report data and other output may be stored within a digital document that is encrypted and stored within a block 265 on the blockchain ledger 210.

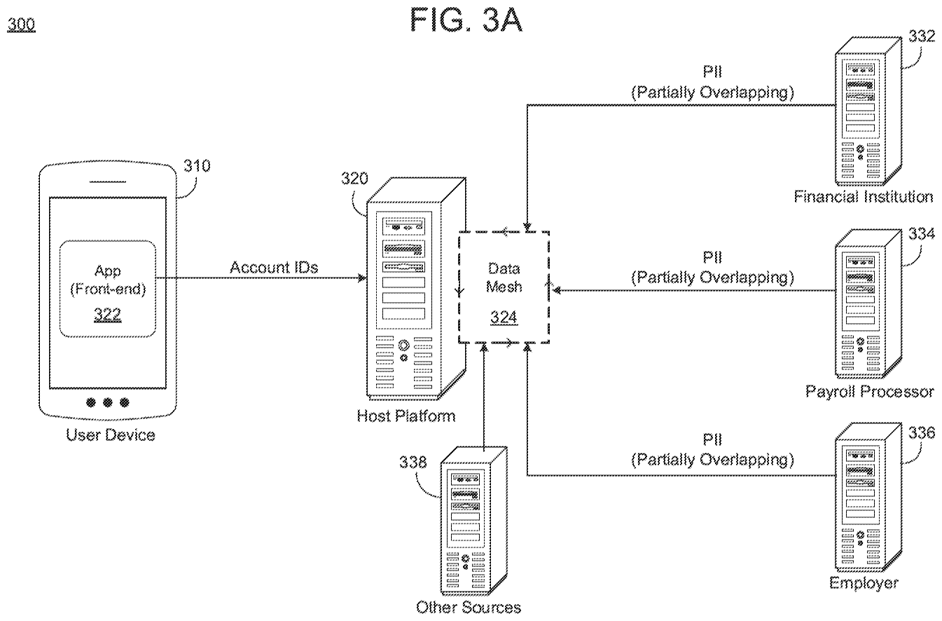

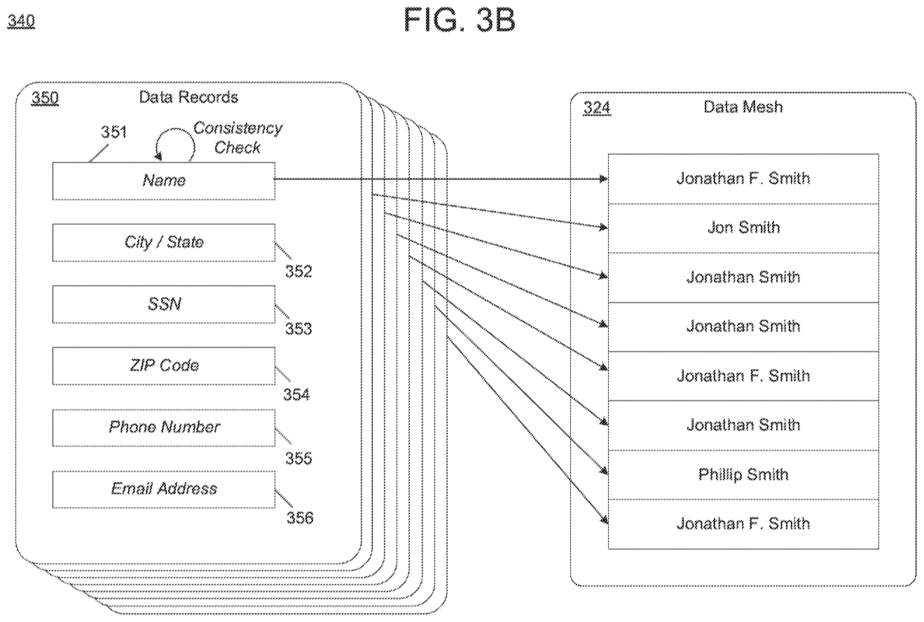

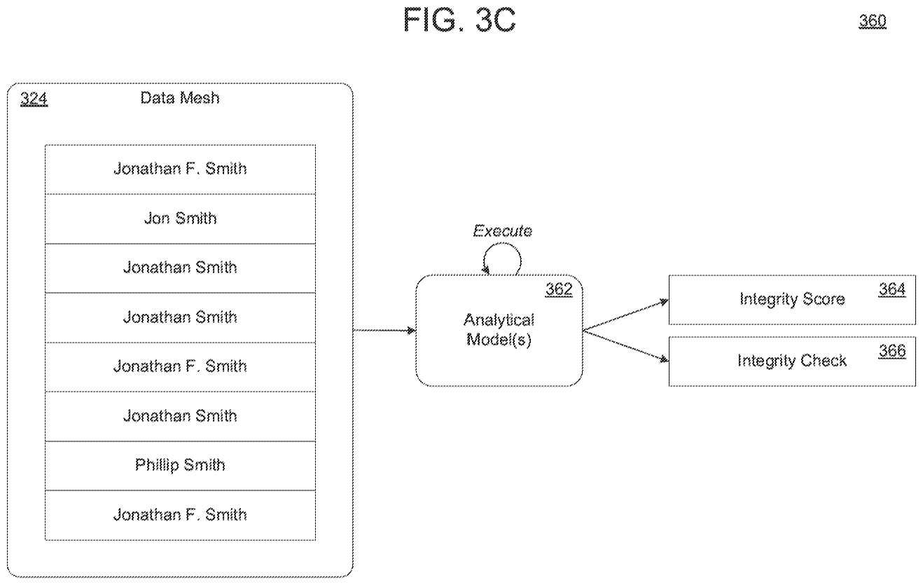

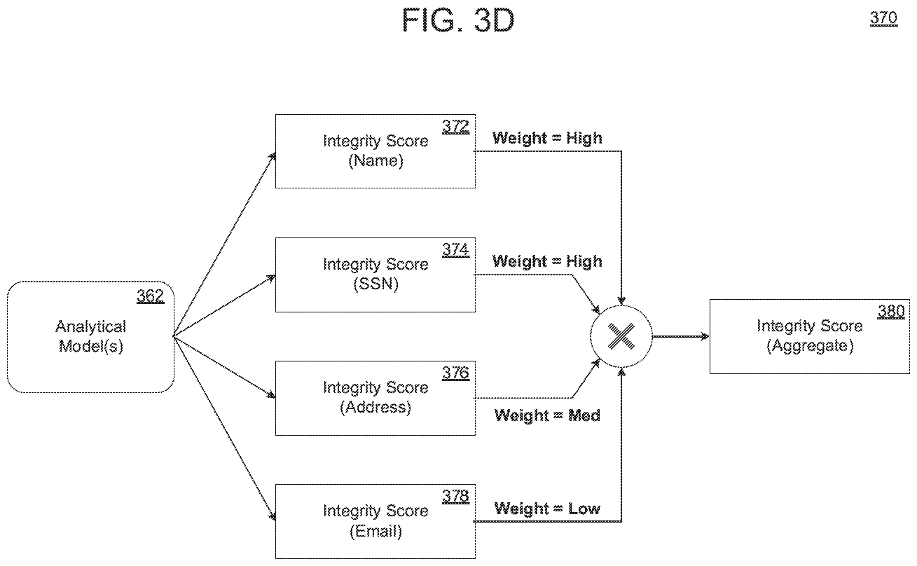

FIG. 3A illustrates a data ingestion process 300 of a host platform 320 in accordance with example embodiments. The data ingestion process 300 may be performed by a blockchain-enabled peer such as those shown in FIG. 1A, a server, a cloud platform, a combination of systems, networks, devices, etc., and the like. In some embodiments, an application server that is coupled to the blockchain network shown in FIG. 1A may perform the data ingestion process 300. As another example, a smart contract or other software program installed on a blockchain-enabled peer and/or a blockchain ledger may perform the data ingestion process.

In this example, the host platform 320 may host an application that performs identity and/or income verification such as described herein. Here, a front-end 322 of the application may be downloaded from a marketplace, etc., and installed on a user device 310, such as a mobile device, a smartphone, a tablet, a laptop, a personal computer, etc. It should also be appreciated that the host platform 320 may host a web application, a website, an authentication portal, or the like, which can receive additional input from the user, such as account numbers, identity information, images, and the like.

In this example, a user may input account numbers and/or routing numbers, login credentials, or the like, of bank accounts, employer accounts (e.g., gig employers, etc.), payroll company accounts, credit accounts, etc., held by trusted sources of truth such as banks, credit agencies, payroll processors, employers/organizations, institutions, and the like, into one or more input fields displayed within a user interface of the front-end 322 of the application and submit them to the host platform 320 by clicking on a button or the like within the user interface of the front-end 322. For example, the user device 310 and the host platform 320 may be connected via the Internet, and the front-end 322 may send the information via an HTTP message, an application programming interface (API) call, or the like. When the account identifiers are transmitted, a response containing relevant account information and the like may be received.

In response to receiving the account information, the host platform 320 may register/authenticate itself with various trusted sources of truth where the accounts/user accounts are held/issued. For example, the host platform may perform a remote authentication protocol/handshake with a financial institution server 332, a payroll processor server 334, an employer server 336, another data source 338, and the like, based on user account information that includes an account issued by the bank, a source of funds from the payroll processor, and an employer that pays the user, or as appropriate for the system being interfaced for data provision. These accounts provide the host platform with a unique mesh of partially-overlapping data sets that can be combined into one larger data set and analyzed. In the example embodiments, the combination of data from the different sources of truth (e.g., financial institution server 332, the payroll processor server 334, the employer server 336, and the other sources 338) can be combined into a data mesh 324 by the host platform 320. It should also be appreciated that the user may manually upload data such as documents, bank statements, account credentials, and the like, in a format such as a .pdf, .docx, spreadsheet, XML file, JSON file, etc. Furthermore, optical character recognition (OCR) may be performed on any documents, files, bank statements, etc. obtained by the host platform 320 to extract attributes from such documents and files.

The authentication process may include one or more API calls being made to each of the different third-party services (e.g., bank, payroll, employer, etc.) via a back-end of the software application on the host platform 320 to establish a secure HTTP communication channel. For example, the back-end of the software application may be embedded or otherwise provisioned with access credentials of the user for accessing the different third-party services. The back-end may then use these embedded, provisioned, and/or otherwise securely stored credentials to establish or otherwise authenticate itself with the third-party services as an agent of the user. Each authenticated channel may be established though a sequence of HTTP communications between the host platform 320 and the various servers. The result is a plurality of web sessions between the host platform 320 and a plurality of servers, respectively. The host platform 320 can request information/retrieve information from any of the servers, for example, via HTTP requests, API calls, and the like. In response, the user data can be transmitted from the servers to the host platform 320 where it can be combined the data mesh 324 for further processing. It is important to further appreciate that in addition to requesting and retrieving this information, in some embodiments the host platform 320 may also be configured to receive event-driven data via webhooks or the like, to ensure data freshness, accuracy, etc.

FIGS. 3B-3D illustrate a process of verifying a user based on personally-identifiable information (PII) in accordance with example embodiments. The process may be performed by a blockchain-enabled peer, as well as any other server or host platform mentioned herein. Referring to FIG. 3B, there is shown a process 340 of performing a consistency check on a particular field of PII (i.e., a name value) stored in each of a plurality of data records obtained from multiple sources of truth. Referring to FIG. 3B, a corpus of data records 350 is shown. Here, each of the data records may have some form of PII, such as a name value 351, a city/state value 352, SSN value 353, ZIP Code value 354, phone number value 355, email address value 356, and the like.

In this example, a value for name 351 is separately identified from each (or most) of the data records and compared to each other for consistency across records. Here, the corpus of data records 350 can be read by the host platform to identify name values 351 in each of the data records. The name values 351 can be extracted and stored in a table, a file, a document, or the like, and/or stored together in the same file, record, or other instantiation of a data structure, or the like, within the data mesh 324. If one or more data records do not have a name value, they can be ignored or omitted, or their absence can be part of the consistency checking process and algorithm. In this example, eight (8) name values are identified from PII included in eight different data records where some of the records are from various/differing sources of truth. The name values can be stored in the same file, record, or other instantiation of a data structure, or the like, in the data mesh 324 by the host platform even though they are extracted from different records. It should be further appreciated that in some embodiments, name values can be aggregated by source or account, for example, grouping transaction records to compare names associated with a plurality of different accounts, financial institutions, or the like.

FIG. 3C illustrates a process 360 of analyzing the data mesh 324 including the name values for consistency. In this example, components of the data mesh 324 can be input into one or more analytical models 362, such as a machine learning model, heuristic, or statistical model, which can perform a consistency check. As a non-limiting example, the analytical models 362 may be machine learning models such as fuzzy matching models, similarity assessments, Natural Language Processing (NLP) techniques, or the like. In this example, the purpose of the analytical model 362 is to determine how different/similar the name value is across the different data records. The file with the different name values stored in the data mesh 324 may be vectorized (via converting text-based components or features into a sequence of numeric values, etc.), making it possible for the text to be operated on by a digital computer, including machine learning models, and the like. Here, the name value may refer to just the first name, last name, or a combination of names (including the middle name and/or initial, as well as titles, prefixes, and/or suffixes). An output of the analytical models 362 may be an integrity score value 364 (e.g., a value in the range of 0 to 100, inclusive, etc.) and an integrity check value 366, which could be a Yes/No or True/False value that is determined by comparing the integrity score value 364 to a predetermined threshold for that particular field of PII (i.e., for the name in this example). If above the threshold, then the integrity check value 366 would be set to Yes/True to indicate a passing check, otherwise it would be set to No/False. If at the threshold, then the integrity check value 366 could arbitrarily be set to provide Yes/True or No/False, depending on the strictness policies for the system. As an additional embodiment of this process, the analytical models 362 may assign different weights to each data record based on factors such as source of data record, with such weighting being determined through means such as manual configuration or dynamic weighting derived from machine learning models tuned to optimize for predictive validity.

This one consistency check may be enough to perform an identity verification. For example, it may be clear after just one consistency check that this user is not who they claim to be. As another example, it may take multiple different values of PII to be considered. FIG. 3D illustrates a process 370 in which an aggregate integrity score 380 is created. Here, the host platform may perform a respective consistency check for multiple different values of PII simultaneously (in parallel) with one another. For example, each consistency check may be performed in parallel by different cores of a multi-core processor or different threads of another execution engine. As another example, the consistency checks may be performed sequentially, one after the other, or otherwise batched.

In FIG. 3D, four different integrity scores 372, 374, 376, and 378 are generated for four different fields of PII (i.e., name, SSN, address, and email, respectively) across the corpus of data records from the data mesh. Furthermore, the integrity scores 372, 374, 376, and 378 can be individually weighted differently (if desired, and including the possibility of zero-valued weights) and then aggregated together and potentially normalized to a predetermined scale by a function or model to create the aggregated integrity score 380. This aggregated integrity score 380 can be used to make a final decision on whether the identity of the user is verified or whether it is not.

Based on one or more integrity scores, the back-end of the software application may make a decision of Yes or No (or True or False) that the identity is verified. This information may then be used to modify or otherwise annotate via reference the original corpus of data records in the data mesh to include a value for such a decision. As another example, the identity verification process result, such as one or more of the integrity scores, may be an input into a decision by the back-end of the software application on whether to activate a new account with the software application based on the identity verification determination. Here, the host platform may only activate the account when the integrity score and/or integrity check values satisfy predefined thresholds. If so, the activation may enable the user to participate in the software application as an active user. This may give the user rights to send messages to other users and/or administrators of the software application, create an account profile, browse web listings, browse employment opportunities, submit and/or update job or employment applications, prepare benefit-related applications, and the like.

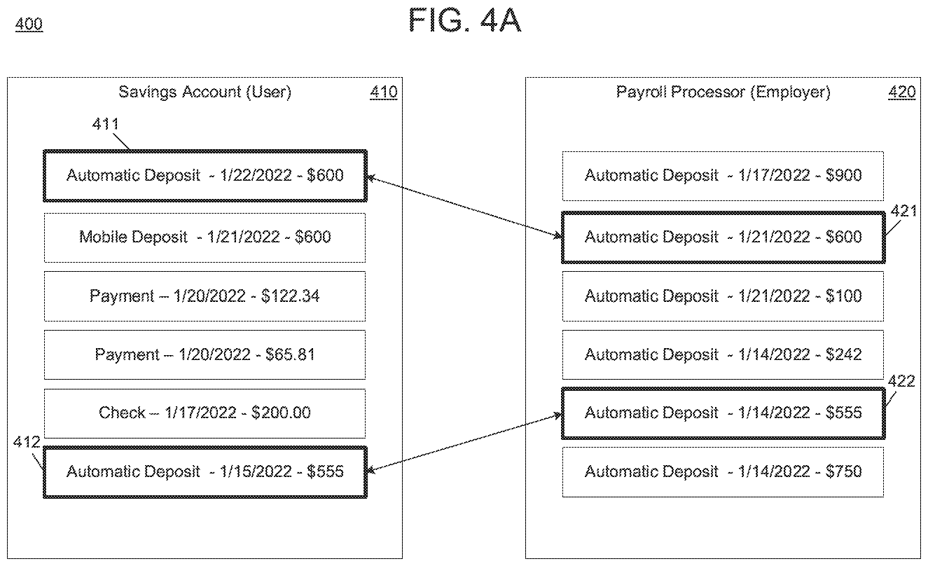

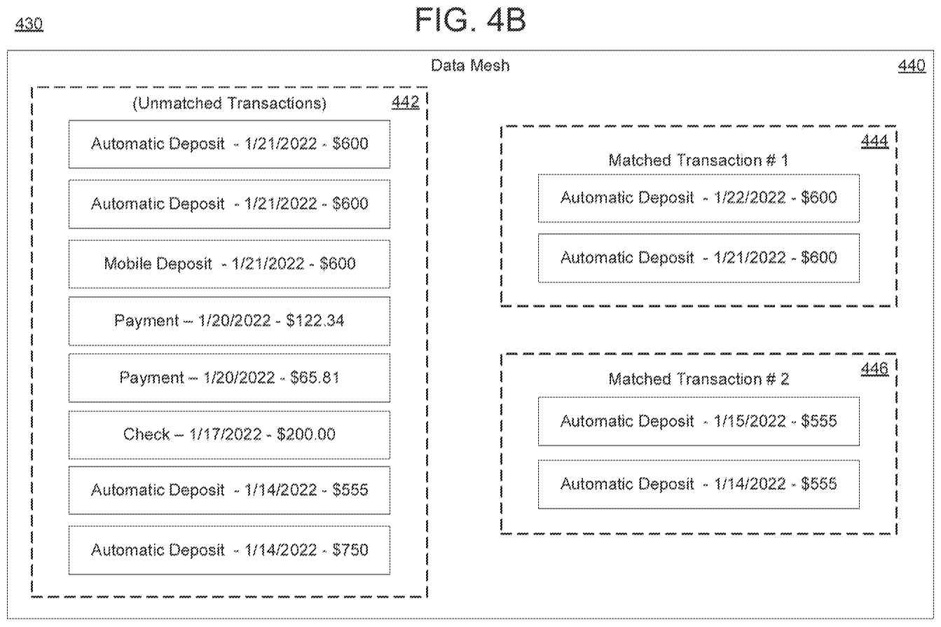

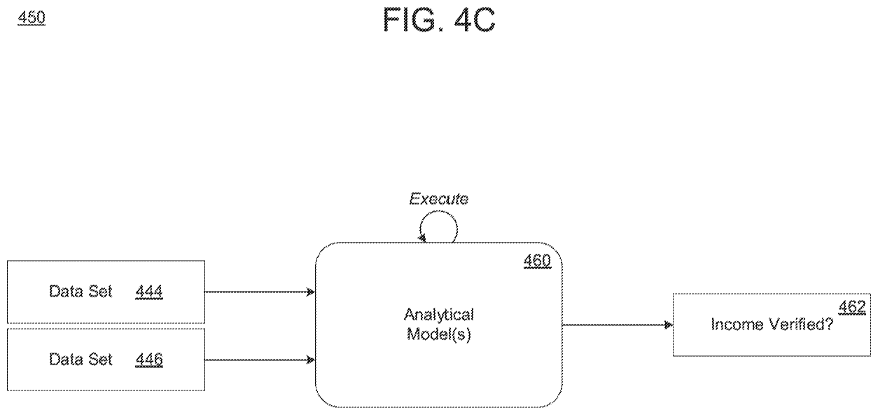

FIGS. 4A-4C illustrate a process of verifying income-based records in accordance with example embodiments. The process may be performed by a blockchain-enabled peer, as well as any other server or host platform mentioned herein. For example, FIG. 4A illustrates a process 400 of comparing partially overlapping transaction records from data sets 410 and 420, respectively. In this example, the transaction data sets 410 and 420 are from two different financial accounts including a user's savings account and a payroll processor payment account associated with the user's employer, respectively. In this example, the host platform may perform a transaction string cleaning process as described in U.S. patent application Ser. No. 17/342,622, filed on Jun. 9, 2021, in the United States Patent and Trademark Office, as well as its continuation in U.S. patent application Ser. No. 17/867,958, filed on Jul. 19, 2022, in the United States Patent and Trademark Office, and a transaction reconciliation and deduplication process as described in U.S. patent application Ser. No. 17/835,044, filed on Jun. 8, 2022, in the United States Patent and Trademark Office, the entire disclosures of which are incorporated herein by reference for all purposes.

In the example of FIG. 4A, the host platform detects that a transaction 411 in the user's savings account matches/corresponds to a transaction 421 in the payment account of the payroll processor. Likewise, a transaction 412 in the user's savings account corresponds to a transaction 422 in the payment account of the payroll processor. In other words, the host platform detects that two transaction records within account summaries of the two accounts hosted by the trusted sources correspond to each other (i.e., they are from the same financial transaction, respectively). In this case, the two accounts may be the opposite sides (i.e., counterparties) of a financial transaction (e.g., payor and payee). As another example, both accounts may be user accounts and the corresponding transaction records may be duplicates or copies with differences that result from the different financial entities processing the transactions.

Based on the results of the detection process, the host platform may create different files or records within the data mesh as shown in the process 430 of FIG. 4B. In this example, the host platform generates three data sets including an unmatched transaction data set 442, a first matched transaction data set 444, and a second matched transaction data set 446, within data mesh 440 of the host platform.

Thus, the host platform of the example embodiments is able to read through or otherwise process transaction data sets from different trusted sources and identify common/linked transactions between two or more transaction data sets. In other words, the host platform identifies transactions that overlap and/or otherwise correspond. This redundancy and/or correspondence can be used for verification purposes as noted by the above-incorporated patent applications.

FIG. 4C illustrates a process 450 of processing the second and third data sets 444 and 446 from the data mesh via an analytical model 460. An output 462 of the analytical model 460 could be a determination of whether the transactions are duplicates, whether the transactions are indeed income related, whether the income attributed to the transactions is verified, or the like. In the case of output 462, the output is a determination of whether or not income is verified. For example, the output 462 may include a score, a Yes/No evaluation or other binary value, and the like. The host platform may clean the data in the data mesh so that other parts of the system or systems can access and process the data as desired (e.g., via fraud detection and income verification, or another combination of verification platform assessments and/or checks). FIG. 4C can be seen to represent how the income verification process can combine all the pieces together to deliver an output. For example, the process might use Identity Verification with certain thresholds, perform Transaction Integrity Checks with other thresholds, and decide or otherwise be configured not to use geographic verification, etc.

Prior to and/or during the income verification process described in the examples of FIGS. 4A-4C, the host platform may also enhance the transaction records through a process referred to as transaction string cleaning. The transaction strings contained in the transaction records can be analyzed to identify additional details of the transaction that are not expressly present in the transaction record or the transaction string, including counterparty names, geographic location, transaction types, transaction classifications, etc.

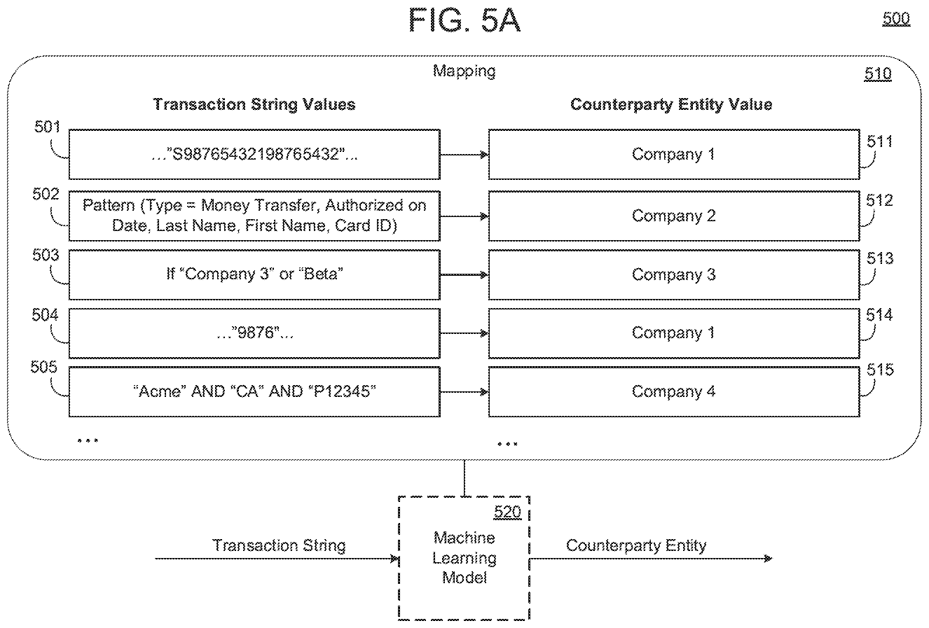

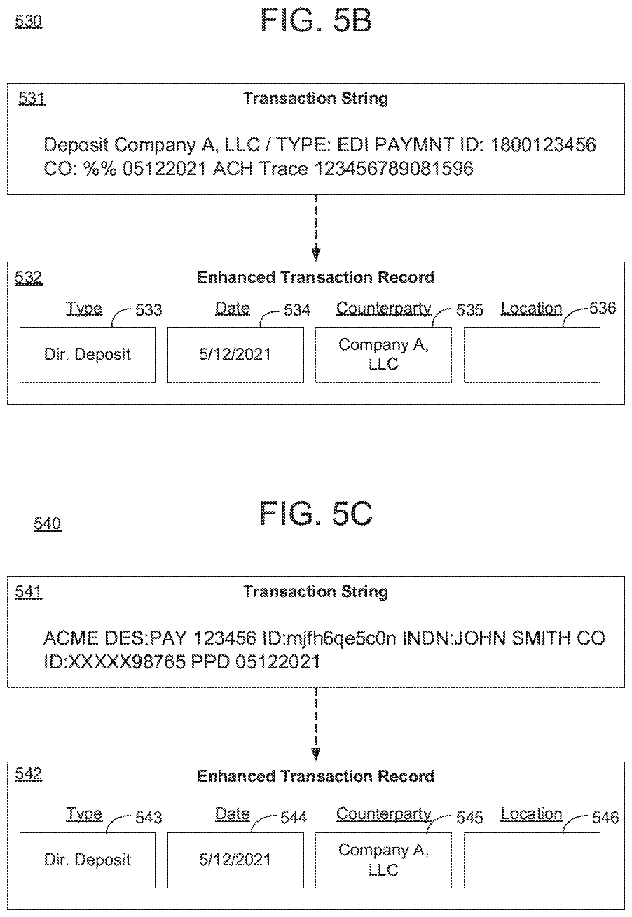

FIG. 5A illustrates a process 500 of mapping transaction strings from transaction records to counterparty entities via a machine learning model 520 in accordance with an example embodiment. As described herein, a counterparty refers to a party of the transaction (e.g., a payor, etc.) when viewed from a transaction record of another party to the transaction (e.g., a payee, etc.). Therefore, the payee may have an account summary with transaction records including payments from the payor who is the counterparty viz. the payee's transaction record. Likewise, the payee is the counterparty viz. the payor's transaction record. The transaction strings of those payment transactions may not expressly list the name of the counterparty. The transaction string cleaning process may identify such counterparty and use that data when performing the income verification to further enhance the results of the verification process (i.e., to make them more accurate, etc.).

Referring to FIG. 5A, a host platform, such as a blockchain-enabled peer, may store the machine learning model 520 (or otherwise call the machine learning model 520 if embodied as an external program or service from the blockchain-enabled peer, for example). Here, the machine learning model 520 may be trained from known mappings to learn mapping relationships between transaction string values and/or value components 501, 502, 503, 504, and 505 and corresponding counterparty entities 511, 512, 513, 514, and 515, respectively, based on historical mappings, which may be manually entered or previously mapped or otherwise learned by the machine learning model 520. It should also be appreciated that other aspects of the transaction record (besides the transaction string or in addition to the transaction string) may be mapped to a counterparty entity. For example, a payment type, a payment data component or value, a geographical location, etc. may be used to map a transaction record to a counterparty. That is, mappings predicted by the machine learning model 520, which may be confirmed first by a user or a host, may be used to retrain the machine learning model 520, thus creating training improvements from the operating data created by the host platform.

In some embodiments, the machine learning model 520 may be a neural network designed for the task of named entity recognition, which in this case classifies each word in a transaction string as part of a counterparty entity name, or not. The neural network may reason this assignment or classification by observing word placement and linguistic dependencies formed by other words in the transaction string. Accordingly, the machine learning model 520 is able to generalize over any transaction string format, as there are numerous possible formats that hard-coded rules would miss. The only data passed to the machine learning model 520 to make a prediction is the transaction string itself. Of course, some embodiments could include heuristics and/or rules, which may result from or otherwise inform, modify, order, replace, and/or enhance machine learning models.

In some embodiments, the input may be the transaction string and the output may be the same data structure (e.g., document, file, table, spreadsheet, etc.) in which the transaction string is input with one or more additional values added including the identified counterparty entity and possibly other data such as date, location, payment type, and the like. In this way, the translation service may modify the input file to include a value or multiple values within a data structure thereof that makes it more helpful for processing by an addition analytics service.

FIGS. 5B and 5C illustrate processes 530 and 540, respectively, of translating a transaction string into a counterparty entity value in accordance with example embodiments. Referring to FIG. 5B, a transaction string 531 may be input to the host system (e.g., a blockchain-enabled peer, a server, etc.), and the output may be the enhanced transaction data record 532. The enhanced transaction data record 532 may include a plurality of fields 533, 534, 535, and 536 for storing data values that are extracted, identified, and/or inferred from the transaction string 531. Here, the translation service may identify the counterparty entity is “Company A, LLC”, whose name is explicitly recited within a transaction string 531. In addition, the translation service may identify additional details such as a type of the transaction, a transaction classification (e.g., a reason, explanation, category, or the like), a date of the transaction, a geographic location, or the like. However, in this example, since this is a direct deposit type of transaction, there is no geographic location specified in the enhanced transaction record 532. The resulting data values that are identified by the translation service may be stored within data fields 533, 534, and 535 of the enhanced transaction record 532, while the data field 536 may be left blank or empty.

FIG. 5C illustrates another example of identifying the counterparty entity. Here, a transaction string 541 is input to the host system and an enhanced transaction data record 542 is output. The enhanced transaction data record 542 includes a plurality of fields 543, 544, 545, and 546 for storing data values that are identified and/or inferred from the transaction string 541. Unlike the example in FIG. 5B, in the example of FIG. 5C, the counterparty entity “Company A, LLC” is not expressly listed by name within the transaction string 541. Instead, a payroll processor name (Acme) of the employer is listed within the transaction string. In this example, the machine learning model 520 (shown in FIG. 5A), or an ensemble of models, etc., may be executed on the transaction string 541 to implicitly map one or more substrings within the transaction string 541 to the counterparty entity name (Company A, LLC). For example, the combination of substrings “Acme”, “John Smith” and “8765” may be mapped to or otherwise be used to identify or predict the name of “Company A, LLC” by the machine learning algorithm, for example as part of a multi-class classification algorithm; it should be appreciated that the machine learning classifier could also be constructed in the form of an ensemble of machine learning models, e.g., in performing a classification. The resulting data values that are identified by the translation service may be stored within the data fields 543, 544, and 545, while the data field 546 may be left empty or blank, since there is not a clear geographic location of the direct deposit. However, the host platform may fill in or otherwise specify or approximate values for the location fields 536 and/or 546, should the geographic location of the user be identified from the transaction records, including the transaction string and other information included in the transaction records.

In addition to enhancing the transaction records, the host platform described herein may “reconcile” transaction records prior to and/or during the income verification process described in FIGS. 4A-4C. The reconciliation process may identify matching transaction records such as two transactions from balancing or opposing sides of the same transaction and duplicate transaction records from the same side of the transaction. This process may be used to reduce the total number of transaction records that are processed by the income verification process. Furthermore, the process may identify “balancing” transactions that represent two sides of the same transaction. These “balanced” transactions can be used to verify that the same amount of money that was sent to a person was the same amount of money that was deposited. This can also be used to confirm that income was sent and received.

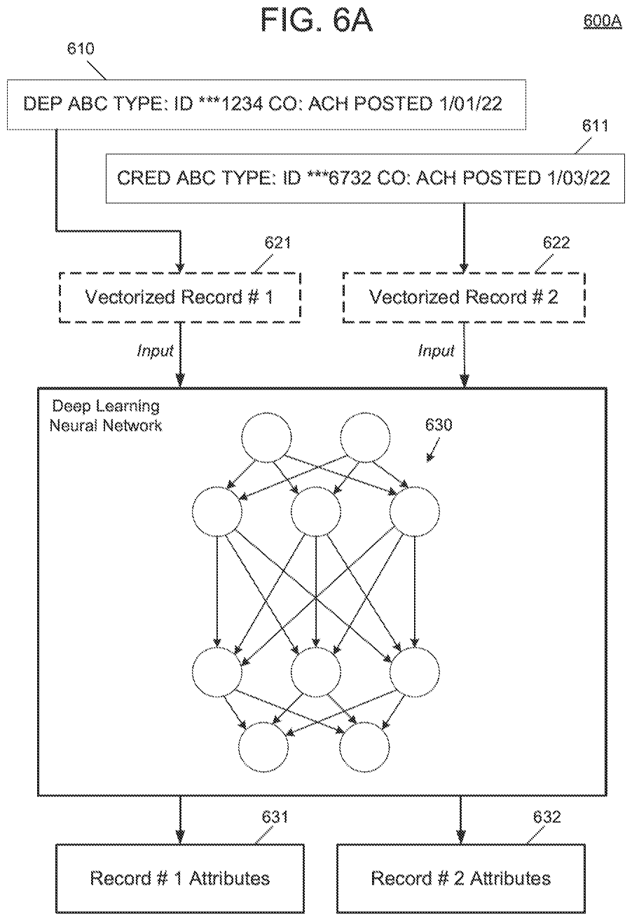

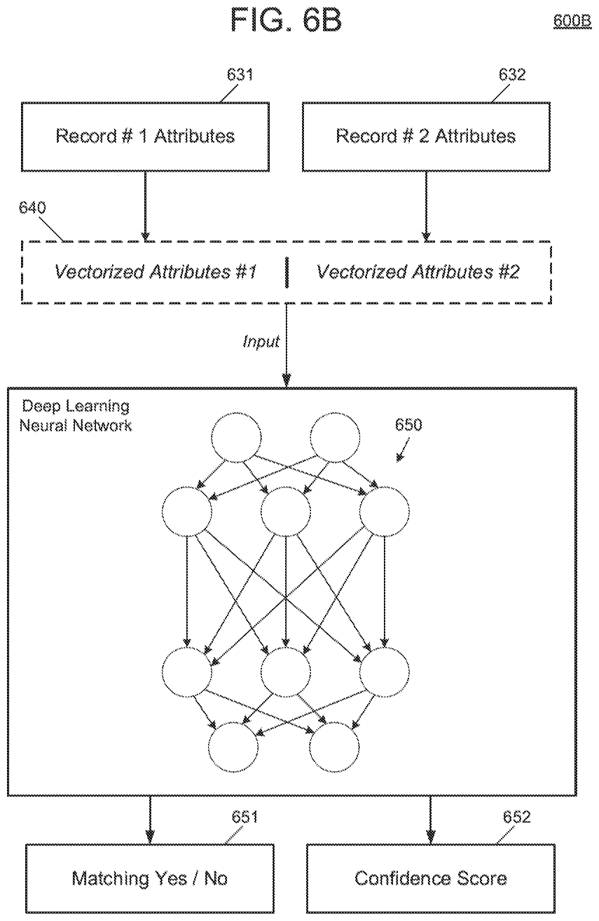

FIGS. 6A and 6B illustrate an example of two machine learning processes that are performed by two machine learning models that work in sequence. However, it should be appreciated that both processes may be performed at the same time by the same machine learning model. In other words, the examples of FIGS. 6A and 6B are not meant to limit the possible use of machine learning by the example embodiments, but merely for purposes of example. The machine learning models described herein may be integrated within a larger machine learning service that is also hosted by the host platform and that can be accessed via application programming interface (API) calls or the like, on the host platform. For example, an API call may specify a particular type of machine learning model to execute from among a plurality/catalogue of machine learning models, heuristics, and/or machine-learning-generated/informed heuristics. The API call may also include the input data (such as the transaction string, etc.) to be processed by the machine learning model/service.

FIG. 6A illustrates a process 600A of a machine learning model identifying transaction attributes from a transaction record in accordance with an example embodiment. FIG. 6B illustrates a process 600B of a machine learning model matching together two transaction records based on the transaction attributes identified in FIG. 6A, in accordance with an example embodiment. As described in these examples, the transaction “attributes” may be considered to be concrete values for transaction “parameters” described herein throughout. Both processes may be executed by the host platform (e.g., a blockchain-enabled peer, a web server, etc.).

Referring to FIG. 6A, the host platform may select two transaction records 610 and 611 from two different digital documents (e.g., two different bank statements, etc.), from records in a data pull spanning a range of dates not necessarily corresponding to statement periods, etc. These two transaction records 610 and 611 may be processed to identify whether these two transaction representations reconcile to the same transaction. Here, the transaction records 610 and 611 are converted into vectors 621 and 622, respectively. The vectorization process may be performed by any known techniques, including natural language processing (NLP), topic modeling, recurrent modeling, bag of words, bag of n-grams, or the like. By converting the contents of the transaction records, which may contain text and other content, into vectors (numerical content), the data can now be input/entered into a machine learning model 630, such as a deep learning neural network or the like.

In response, the machine learning model 630 may identify respective attributes in each of the transaction records. The machine learning model may output transaction attributes 631 identified by the machine learning model 630 from the transaction record 610 and transaction attributes 632 identified by the machine learning model 630 from the transaction record 611. Transaction attributes may include one or more of a payment amount, a payment date, a counterparty entity, a geographical location, and the like. In some cases, no attributes may be identified.

Next, the process 600B may be used to identify whether these two transaction records 610 and 611 reconcile/match the same transaction. Here, the transaction attributes 631 and 632 may be vectorized into a single vector 640 or multiple vectors, and input into a machine learning model 650, which may or may not be a deep learning neural network, other supervised learning model or the equivalent, or any of the other matching models described herein. In response, the machine learning model 650 may output a determination 651 indicating whether or not the two transaction records reconcile to the same transaction and a confidence score 652, indicating a confidence of the prediction (e.g., an accuracy, likelihood, etc.).

When determining whether a user is eligible for a benefit, such as a benefit offered by a basic income benefits program, unemployment assistance program, or the like, the host platform may perform one or more of an identity verification, an income verification, a fraud detection, and the like, which are described herein as part of the eligibility verification of a user. The host may also retrieve criteria/qualifications of the benefits program that the user wishes to be certified with and determine whether or not the user qualifies for the benefits program based on the retrieved criteria and user-specific data, such as income data and other data of the user, which may be primarily obtained from authorized accounts of the user.

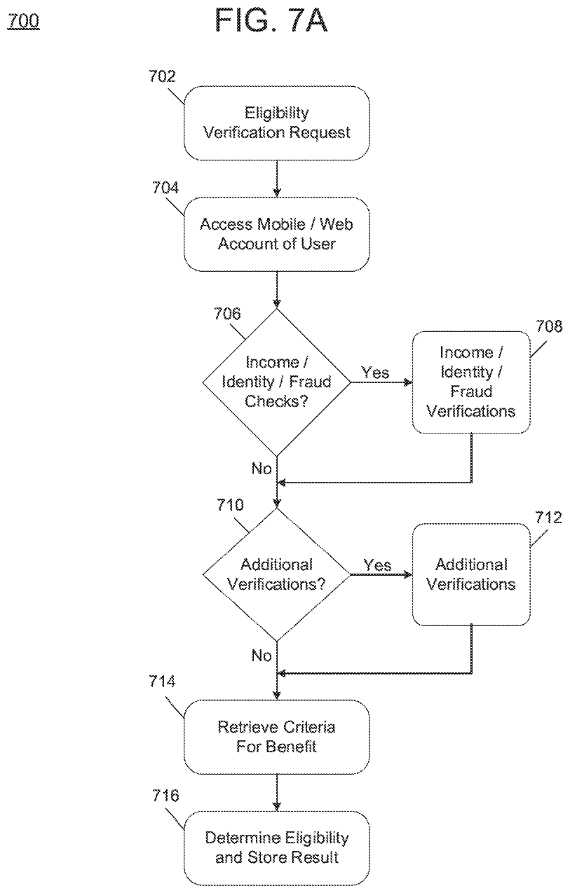

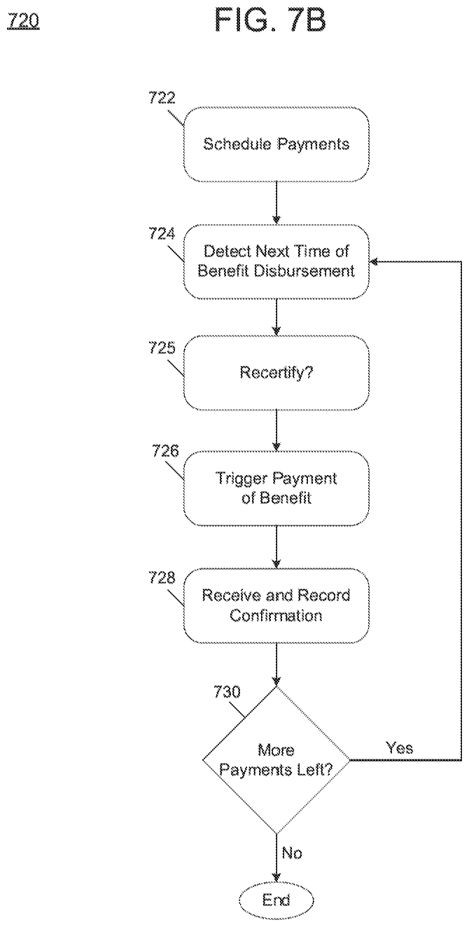

FIG. 7A illustrates a process 700 of verifying eligibility of a user for a benefit in accordance with an example embodiment. The process 700 may be performed by the host platform described herein. At a high level, the process has two main entry points, including one for new users looking to newly certify with a benefits program and one for existing users who need to recertify with the benefits program. In some cases, the existing users may have ongoing basic income grants, unemployment assistance, or the like disbursed on a recuring basis via a scheduler as described herein. This methodology incorporates substantial automation and verification capabilities, including but not limited to means and eligibility criteria (e.g., income, identity, location, other benefits, etc.) testing for new and recertifying users. Additional eligibility checks can be performed as needed, with flexibility for multiple different eligibility check configurations and pathways through the host system, based on user metadata and/or system settings embedded in a policy of the host platform such as within a governance policy of a blockchain, which could be stored in the genesis block of the blockchain ledger, an external reference data store, or the like.

Referring to FIG. 7A, in 702, the process may include receiving a request to verify eligibility of a user for a benefits program. The eligibility may be based on predefined criteria that is defined by the benefits program, such as an unemployment program, a basic income program, a grants program, a disability program, a cash distribution program, an unemployment assistance program, and the like. In 704, the process may identify whether the user is a registered user of the application. If so, the process may perform an analysis on a user's profile stored within the application to determine whether or not the user needs to recertify (i.e., have their eligibility reverified). For example, an amount of time since a last certification may be a trigger if too much time has elapsed (e.g., more than a month, etc.). If the user is not an existing user, the user may create a new account with the software application and provide details of accounts that the use wishes to connect to the host platform during an onboarding process.

In 706, the process determines whether the user should have one or more of an identity verification, an income verification, and fraud checks. In some cases, the process may perform all three of these checks or just one or more of these checks. In other cases, it may be configured not to check for these potential concerns, depending on the goals of the distribution program. Furthermore, the fraud checks may be embedded within the identity verification process. If the host system determines to execute one or more of the means tests, in 708 the checks are executed to identify whether the user meets/satisfies any income and/or identity verification requirements of the benefits program based authenticated data pulled from connected accounts of the user (i.e., connected to a host financial server of the accounts along with access credentials for accessing the user's account data). If the host system determines not to perform any checks, the process may skip to 710 without step 708. In 710, the process determines whether any additional checks are needed, such as means checks that may rely upon information gleaned and determinations made in 706 and 708, and in 712, the process can then execute the additional checks. If no additional checks are needed, then the process skips step 712 and moves to 714.

In 714, the process may calculate basic income, guaranteed income, grant, and/or cash benefits payment amounts based on user data and eligibility checks or look up amounts for existing users. If external confirmation is required, e.g. confirmation by a governmental or other agency, the host platform can trigger an external confirmation service via an endpoint of the external confirmation service, which is stored by the host platform. In 716, the process may determine a final assessment regarding the individual's eligibility for basic income, guaranteed income, grant, and/or cash benefits payments. Furthermore, the host system may generate any relevant reports, confirming with external parties as needed, prior to storing relevant information, calculation outputs, and other metadata in databases and optionally entering key information into an appropriate blockchain-based ledger for verifiable storage. In addition, the eligibility verification may be repeated or re-verified over time (e.g., prior to each disbursement, etc.).

It's important to appreciate at this point that the process shown in the example embodiment described in FIG. 7A could equally apply to assessing an applicant's fit for a job or other employment, where step 714 would be “Retrieve Criteria For Employment Opportunity” or the like, to indicate the goal of the process. Moreover, this process could be used as the applicant gains new employment experience, skills, and the like, to determine eligibility for or quality of match with employment opportunities.

FIG. 7B illustrates a process 720 of automatically disbursing benefit payments in accordance with an example embodiment. The host platform described herein may trigger basic income, guaranteed income, grant, unemployment assistance, and/or cash benefits payments or the like to users. For an existing user, the host platform may determine whether the user needs recertification, and if so, execute a sequence of instructions to perform the steps in the process 700 of FIG. 7A.

It should be appreciated that automatic processes for updating a user's skills, employment, and other relevant information can be leveraged to provide the most up-to-date information for the skills certificate and verification processes.

The host system may receive a request from the user or from the benefits program to disburse payments in an automated manner to the user. In 722, the host system may schedule payments to be made based on administration data pulled from the user's file, blockchain profile, etc. An ongoing scheduler system may schedule future payments and trigger those payments when the time comes using timers such as those embodied in time-to-live (TTL) jobs, or the like. A calculation system can be configured to a particular set of criteria and goals, using user metadata and system settings. The system can determine an amount to pay to a user and a date on which such payment should be made based on details from the user's administration plan. In 724, the host waits until a next payment disbursement time is detected. For example, the host may detect a timer expiring, a time-to-live job expiring, or the like. In this case, the time-to-live job may have a pointer to a scheduled payment stored by the scheduler. Thus, the time-to-live job may also tell the host platform which payment is to be sent.

In 725, the host platform may determine whether or not the user needs to be re-certified. For example, a benefit may require that the user be re-certified prior to each disbursement or on some periodic basis (e.g., once a year, etc.). The recertification process may be performed to ensure that the user is still eligible for the benefit and may include identity verification, income verification, eligibility verification, and the like.

In 726, the host platform triggers the payment. Furthermore, confirmation with external parties regarding report may be received and recorded in 728. In other words, the financial institution that sends the payment can confirm that the payment was sent and even supply proof in the form of a bank statement, transaction record, etc. In some embodiments, the host platform can confirm, then automatically send payment once confirmed. As another example, the host can automatically send payment based on report criteria. Details of the disbursed payment may be stored in application database storage, and optionally stored in an appropriate blockchain storage location. Blockchain storage can vary by use case, including but not limited to using public, private, or permissioned blockchains individually and in tandem. In 730, the process may determine whether or not any additional disbursements exist for the user under the benefits program. If so, the process returns to step 724, otherwise it terminates.

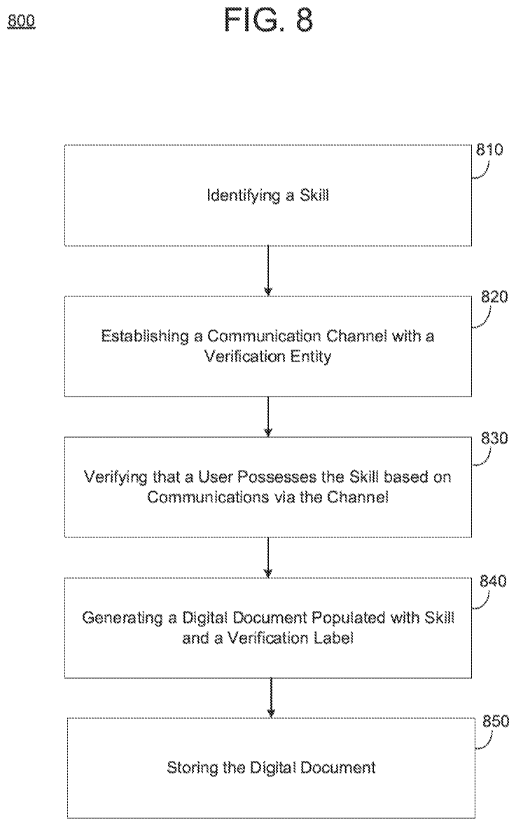

FIG. 8 illustrates a method 800 of generating a certified skills document in accordance with example embodiments. For example, the method 800 may be performed by a host platform such as a cloud platform, a web server, an application server, or the like, which hosts a software application as described herein. Referring to FIG. 8, in 810, the method may include identifying, via a host server, a skill that a user has obtained and a verification entity for the skill based on user data stored in a software application that is hosted by the host server. In 820, the method may include establishing a communication channel between the host server and the verification entity via an application programming interface (API), or the like. In 830, the method may include verifying that the user possesses the skill based on communications exchanged between the host server and the verification entity via the communication channel. In 840, the method may include locating an existing digital document or generating a digital document and then populating the digital document with an identifier of the skill and a label that indicates the skill has been verified, as well as other relevant metadata. In 850, the method may include storing the digital document within a data store.

The above embodiments may be implemented in hardware, in a computer program executed by a processor, in firmware, or in a combination of the above. A computer program may be embodied on a computer readable medium, such as a storage medium or storage device. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

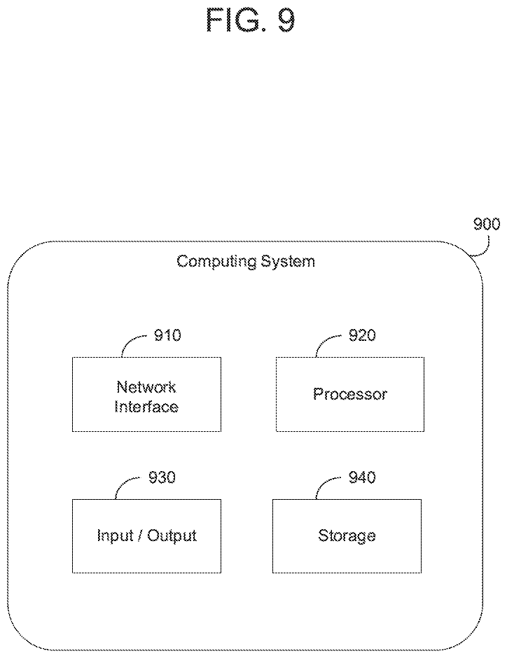

A storage medium may be coupled to the processor such that the processor may read information from, and write information to, the storage medium. In an alternative, the storage medium may be integral to the processor. The processor and the storage medium may reside in an application specific integrated circuit (“ASIC”). In an alternative, the processor and the storage medium may reside as discrete components. For example, FIG. 9 illustrates an example computing system 900 which may process or be integrated in any of the above-described examples, etc. FIG. 9 is not intended to suggest any limitation as to the scope of use or functionality of embodiments described herein. The computing system 900 is capable of being implemented and/or performing any of the functionality set forth hereinabove.

The computing system 900 may include a computer system/server, which is operational with numerous other general purpose or special purpose computing system environments or configurations. Examples of well-known computing systems, environments, and/or configurations that may be suitable for use as computing system 400 include, but are not limited to, personal computer systems, server computer systems, thin clients, thick clients, hand-held or laptop devices, tablets, smart phones, databases, multiprocessor systems, microprocessor-based systems, set top boxes, programmable consumer electronics, network PCs, minicomputer systems, mainframe computer systems, distributed cloud computing environments, databases, and the like, which may include any of the above systems or devices, and the like. According to various embodiments described herein, the computing system 900 may be, contain, or include a tokenization platform, server, CPU, or the like.

The computing system 900 may be described in the general context of computer system-executable instructions, such as program modules, being executed by a computer system. Generally, program modules may include routines, programs, objects, components, logic, data structures, and so on that perform particular tasks or implement particular abstract data types. The computing system 900 may be practiced in distributed cloud computing environments where tasks are performed by remote processing devices that are linked through a communications network. In a distributed cloud computing environment, program modules may be located in both local and remote computer system storage media including memory storage devices.

Referring to FIG. 9, the computing system 900 is shown in the form of a general-purpose computing device. The components of computing system 900 may include, but are not limited to, a network interface 910, a processor 920 (or multiple processors/cores), an input/output 930, which may include a port, an interface, etc., or other hardware, for receiving a data signal from another device, or for outputting a data signal to another device such as a display, a printer, etc., and a storage device 940, which may include a system memory, or the like. Although not shown, the computing system 900 may also include a system bus that couples various system components, including system memory to the processor 920.

The storage 940 may include a variety of computer system readable media. Such media may be any available media that is accessible by computer system/server, and it may include both volatile and non-volatile media, removable and non-removable media. System memory, in one embodiment, implements the flow diagrams of the other figures. The system memory can include computer system readable media in the form of volatile memory, such as random-access memory (RAM) and/or cache memory. As another example, storage device 940 can read and write to a non-removable, non-volatile magnetic media (not shown and typically called a “hard drive”) and/or a solid state drive (SSD). Although not shown, a magnetic disk drive for reading from and writing to a removable, non-volatile magnetic disk (e.g., a “floppy disk”), an optical disk drive for reading from or writing to a removable, non-volatile optical disk such as a CD-ROM, DVD-ROM or other optical media, and/or a flash drive, such as USB drive or an SD card reader for reading flash-based media, can be provided. In such instances, each can be connected to the bus by one or more data media interfaces. As will be further depicted and described below, storage device 940 may include at least one program product having a set (e.g., at least one) of program modules that are configured to carry out the functions of various embodiments of the application.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the present application may take the form of a computer program product embodied in one or more computer readable medium(s) having computer readable program code embodied thereon.

Although not shown, the computing system 900 may also communicate with one or more external devices such as a keyboard, a pointing device, a display, etc.; one or more devices that enable a user to interact with computer system/server; and/or any devices (e.g., network card, modem, etc.) that enable computing system 900 to communicate with one or more other computing devices. Such communication can occur via I/O interfaces. Still yet, computing system 900 can communicate with one or more networks such as a local area network (LAN), a general wide area network (WAN), and/or a public network (e.g., the Internet) via network interface 910. As depicted, network interface 910 may also include a network adapter that communicates with the other components of computing system 900 via a bus. Although not shown, other hardware and/or software components could be used in conjunction with the computing system 900. Examples include, but are not limited to: microcode, device drivers, redundant processing units, external disk drive arrays, RAID systems, tape drives, and data archival storage systems, etc.

As will be appreciated based on the foregoing specification, the above-described examples of the disclosure may be implemented using computer programming or engineering techniques including computer software, firmware, hardware or any combination or subset thereof. Any such resulting program, having computer-readable code, may be embodied or provided within one or more non-transitory computer-readable media, thereby making a computer program product, i.e., an article of manufacture, according to the discussed examples of the disclosure. For example, the non-transitory computer-readable media may be, but is not limited to, a fixed drive, diskette, optical disk, magnetic tape, flash memory, semiconductor memory such as read-only memory (ROM), and the like.

The computer programs (also referred to as programs, software, software applications, “apps”, or code) may include machine instructions for a programmable processor, and may be implemented in a high-level procedural and/or object-oriented programming language, and/or in assembly/machine language. As used herein, the terms “machine-readable storage medium” and “computer-readable storage medium” refer to any computer program product, apparatus, platform, and/or device (e.g., magnetic discs, optical disks, memory, programmable logic devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal that may be used to provide machine instructions and/or any other kind of data to a programmable processor.

The above descriptions and illustrations of processes herein should not be considered to imply a fixed order for performing the process steps. Rather, the process steps may be performed in any order that is practicable, including simultaneous performance of at least some steps. Although the disclosure has been described regarding specific examples, it should be understood that various changes, substitutions, and alterations apparent to those skilled in the art can be made to the disclosed embodiments without departing from the spirit and scope of the disclosure as set forth in the appended claims.

1. A server comprising:
a data store and
a processor configured to
identify a skill that a user has obtained and a verification entity of the skill based on user data stored in a software application that is hosted by the server,
establish a communication channel between the host server and the verification entity via an application programming interface (API),
verify that the user possesses the skill based on communications exchanged between the host server and the verification entity via the communication channel,
generate a digital document and populate the digital document with an identifier of the skill and a label that indicates the skill has been verified, and
store the digital document within the data store.

2. The server of claim 1, wherein the processor is configured to embed a digital code into the digital document, map the digital code to an identifier of the digital document, and store the mapping within a mapping table in the data store.

3. The server of claim 2, wherein the processor is further configured to receive scan data comprising a scanned digital code from a computing device, determine that the scanned digital code is mapped to the identifier of the document via the mapping table, and transmit a successful authentication response to the computing device.

4. The server of claim 3, wherein the processor is configured to transmit identifiers of known skills of the user to a user interface of the computing device in response to a determination that the scanned digital code is mapped to the identifier of the document.

5. The server of claim 2, wherein the processor is configured to store the digital document within a blockchain ledger, generate the document via a smart contract installed on the blockchain ledger, and store the mapping within a mapping table embedded in the smart contract.

6. The server of claim 5, wherein the method further comprises receiving scan data comprising a scanned digital code from a computing device, determining that the scanned digital code is mapped to the identifier of the document via the mapping table embedded in the smart contract, and transmitting a successful authentication response to the computing device.

7. The server of claim 1, wherein the processor is further configured to identify a job type of the user from the user data, map the job type to a predefined code, and query a database with the predefined code for a list of skills of the job type.

8. The server of claim 1, wherein the processor is configured to identify a plurality of skills of the user from the list of skills queried from the database, establish independent communication channels with a plurality of verification entities associated with the plurality of skills, verify the plurality of skills via the plurality of independent communication channels respectively based on communications exchanged with the plurality of verifications entities, and populate the digital document with identifiers of the plurality of skills with a plurality of verification labels.

9. A method comprising:
identifying, via a host server, a skill that a user has obtained and a verification entity of the skill based on user data stored in a software application that is hosted by the host server;
establishing a communication channel between the host server and the verification entity via an application programming interface (API);
verifying that the user possesses the skill based on communications exchanged between the host server and the verification entity via the communication channel;
generating a digital document and populating the digital document with an identifier of the skill and a label that indicates the skill has been verified; and
storing the digital document within a data store.

10. The method of claim 9, wherein the generating comprises embedding a digital code into the digital document, mapping of the digital code to an identifier of the digital document, and storing the mapping within a mapping table in the data store.

11. The method of claim 10, wherein the method further comprises receiving scan data comprising a scanned digital code from a computing device, determining that the scanned digital code is mapped to the identifier of the document via the mapping table, and transmitting a successful authentication response to the computing device.

12. The method of claim 11, wherein the transmitting comprises transmitting identifiers of known skills of the user to a user interface of the computing device in response to determining that the scanned digital code is mapped to the identifier of the document.

13. The method of claim 10, wherein the storing comprises storing the digital document within a blockchain ledger, the generating is performed via a smart contract installed on the blockchain ledger, and the storing comprises storing the mapping within a mapping table embedded in the smart contract.

14. The method of claim 13, wherein the method further comprises receiving scan data comprising a scanned digital code from a computing device, determining that the scanned digital code is mapped to the identifier of the document via the mapping table embedded in the smart contract, and transmitting a successful authentication response to the computing device.

15. The method of claim 9, wherein the processor is further configured to identify a job type of the user from the user data, map the job type to a predefined code, and query a database with the predefined code for a list of skills of the job type.

16. The method of claim 9, wherein the identifying comprises identifying a plurality of skills of the user from the list of skills queried from the database, the establishing comprises establishing independent communication channels with a plurality of verification entities associated with the plurality of skills, the verifying comprises verifying the plurality of skills via the plurality of independent communication channels respectively based on communications exchanged with the plurality of verifications entities, and the populating comprises populating the digital document with identifiers of the plurality of skills with a plurality of verification labels.

17. A computer-readable storage medium comprising instructions which when executed by a processor cause a computer to perform a method comprising:
identifying, via a host server, a skill that a user has obtained and a verification entity of the skill based on user data stored in a software application that is hosted by the host server;
establishing a communication channel between the host server and the verification entity via an application programming interface (API);
verifying that the user possesses the skill based on communications exchanged between the host server and the verification entity via the communication channel;
generating a digital document and populating the digital document with an identifier of the skill and a label that indicates the skill has been verified; and
storing the digital document within a data store.

18. The computer-readable storage medium of claim 17, wherein the generating comprises embedding a digital code into the digital document, mapping of the digital code to an identifier of the digital document, and storing the mapping within a mapping table in the data store.

19. The computer-readable storage medium of claim 18, wherein the method further comprises receiving scan data comprising a scanned digital code from a computing device, determining that the scanned digital code is mapped to the identifier of the document via the mapping table, and transmitting a successful authentication response to the computing device.

20. The computer-readable storage medium of claim 17, wherein the storing comprises storing the digital document within a blockchain ledger, the generating is performed via a smart contract installed on the blockchain ledger, and the storing comprises storing the mapping within a mapping table embedded in the smart contract.
